(19) United States
(12) Patent Application Publication
(10) Pub. No.: US 2026/0148237 A1
(43) Pub. Date: May 28, 2026

(54) PRESET SPENDING LIMIT ADJUSTMENT DURING A TRANSACTION

(71) Applicant: Motorola Mobility LLC, Chicago, IL (US)

(72) Inventors: Amit Kumar Agrawal, Bangalore (IN); Krishnan Raghavan, Bangalore (IN); Hariprasad Shanbhogue Alampady, Bengaluru (IN)

(73) Assignee: Motorola Mobility LLC, Chicago, IL (US)

(21) Appl. No.: 18/957,582

(22) Filed: Nov. 22, 2024

(51) Int. Cl. G06Q 20/40; G06Q 20/32; G06Q 20/42

(52) U.S. Cl. CPC G06Q 20/405; G06Q 20/3223; G06Q 20/42

(57) ABSTRACT

In aspects of preset spending limit adjustment during a transaction, a mobile device obtains an indication that a purchase amount of a transaction exceeds a preset spending limit for a payment method used for the transaction. The mobile device indicates that the purchase amount of the transaction exceeds the preset spending limit. The mobile device receives an authorization input during processing of the transaction to increase the preset spending limit, and the transaction is allowed to complete based on the authorization input to increase the preset spending limit.

### BACKGROUND

Given the advancements in digital banking, many people no longer carry paper money, or even credit cards, opting rather for digital banking accounts that are accessible on a device, such as a mobile phone, portable computer, or any other type of electronic and/or computing device. Although credit and/or debit cards are widely usable as forms of convenient digital banking payment methods, for safety purposes, the debit and charge cards associated with the digital banking accounts come with preset spending limits for various categories of payments. For example, a user can set limits for the physical use of a card at a point-of-sale (POS) device, such as when purchasing a product in a retail shop, and the user can set a lower limit for contactless, no-PIN sales transactions. This provides an extra level of transaction security so that attempted transactions for spending amounts above the preset spending limits will be declined, which helps to alleviate fraudulent purchases in the event that a charge card is lost or stolen, and then misused.

### BRIEF DESCRIPTION OF THE DRAWINGS

Implementations of the techniques for preset spending limit adjustment during a transaction are described with reference to the following Figures. The same numbers may be used throughout to reference like features and components shown in the Figures.

FIG. 1 illustrates an example system for preset spending limit adjustment during a transaction in accordance with one or more implementations as described herein.

FIGS. 2-6 illustrate example methods for preset spending limit adjustment during a transaction, in accordance with one or more implementations of the techniques described herein.

FIG. 7 illustrates various components of an example device that may be used to implement the techniques for preset spending limit adjustment during a transaction, as described herein.

### DETAILED DESCRIPTION

Implementations of the techniques for preset spending limit adjustment during a transaction may be implemented as described herein. A mobile device, such as any type of a wireless device, media device, mobile phone, flip phone, client device, tablet, computing, communication, entertainment, gaming, media playback, and/or any other type of computing and/or electronic device, or a system of any combination of such devices, may be configured to perform techniques for preset spending limit adjustment during a transaction, as described herein. In one or more implementations, a mobile device includes a payment transaction manager, which can be used to implement aspects of the techniques described herein. Additionally, or alternatively, a mobile device communicates (e.g., interfaces) with a point-of-sale (POS) device to facilitate transaction purchases. A POS device may include a cash register, credit card reader, tablet device, smartphone, computer, and/or any combination of such devices used to process sales transactions in a retail environment. Additionally, or alternatively, a mobile device communicates (e.g., interfaces), either directly or indirectly, with a transaction service that approves or declines sales transactions, such as a sales transaction initiated by the mobile device at a POS device.

Conventionally, many people no longer carry paper money, or even credit cards, opting rather for digital banking accounts that are accessible on a mobile device. Although credit and/or debit cards are widely usable as forms of convenient digital banking payment methods, for safety purposes, the debit and charge cards associated with the digital banking accounts come with preset spending limits for various categories of payments. For example, a user can set limits for the physical use of a card at a POS device, such as when purchasing a product in a retail shop, and the user can set a lower limit for contactless, no-PIN sales transactions. This provides an extra level of transaction security so that attempted transactions for spending amounts above the preset spending limits will be declined, which helps to alleviate fraudulent purchases in the event that a charge card is lost or stolen, and then misused.

This type of transaction security setup for preset spending limits may also introduce an inconvenience for a user who uses his or her own debit or charge cards, either in physical form, or as a digital banking payment method, such as on a mobile phone device. In some situations, a transaction may be declined or rejected even when a charge card is used by the owner of the card, and the spending amount of the transaction exceeds the preset spending limit. This can further result in a poor user experience at a point-of-sale because an error or decline message does not reflect the actual reason that the transaction has been declined (e.g., there is no indication that a preset spending limit has been exceeded, just a decline notice). This may exasperate an already stressful experience for the user, particularly in a crowded retail environment with several other people waiting to complete purchases, or in a different city or country where language differences may also be a hinderance. This confluence of concerns may result in a user attempting to resort to alternative, less optimal payment methods, or the user may have no payment alternative at all, causing abandonment of a purchase, which is a loss for both the consumer and the retailer. Even in a situation where the user realizes that a spending limit is the reason for the payment being declined, it can be time-consuming and/or difficult to attempt to increase the preset spending limit for the current transaction, and there is always the chance the user forgets to then later revert the override, which exposes a security risk.

Accordingly, the described techniques for preset spending limit adjustment during a transaction provide that a user can maintain spending limit security for a purchase transaction that exceeds a preset spending limit, while also providing the convenience of being able to quickly override the preset spending limit as-needed for a transaction. An increase of a preset spending limit can be authorized during the processing of a transaction (e.g., “on the fly”) for a particular transaction category by the user (e.g., primary owner) of a mobile device with a digital banking payment method, and the preset spending limit can be restored back the previous preset limit post transaction.

In one or more implementations, a user with a mobile device can initiate a purchase transaction, such as at a POS device with a digital banking payment method stored on the mobile device. The POS device communicates to a transaction service (e.g., a 3^{rd} party provider) that processes the purchase transaction, including determining whether the digital banking payment method has enough of a balance to complete the purchase, and whether the purchase amount is within a preset spending limit. If the purchase amount exceeds the preset spending limit, then the transaction service can communicate (e.g., interface) with the mobile device, via a banking system and/or via a banking application on the mobile device that is associated with the digital banking payment method.

The user of the mobile device can be alerted that the purchase amount for the transaction exceeds the preset spending limit. The user can then approve a temporary, over-limit transaction, such as via an interface displayed on the mobile device, by voice command, or by any other type of a user approval interaction. The transaction service receives the authorization input for the spending limit adjustment to temporarily increase the preset spending limit, and the transaction service allows the purchase transaction to go through with approval. Notably, the authorization input to temporarily increase the preset spending limit allows the purchase transaction to occur while the initial transaction from the POS device is processing by the transaction service, rather than simply just declining the transaction as is typical if an over-limit spending threshold is detected. Additionally, the preset spending limit can be reverted to the previous, lower spending limit after the purchase transaction is concluded.

While features and concepts of the described techniques for preset spending limit adjustment during a transaction is implemented in any number of different devices, systems, environments, and/or configurations, implementations of the techniques for preset spending limit adjustment during a transaction are described in the context of the following example devices, systems, and methods.

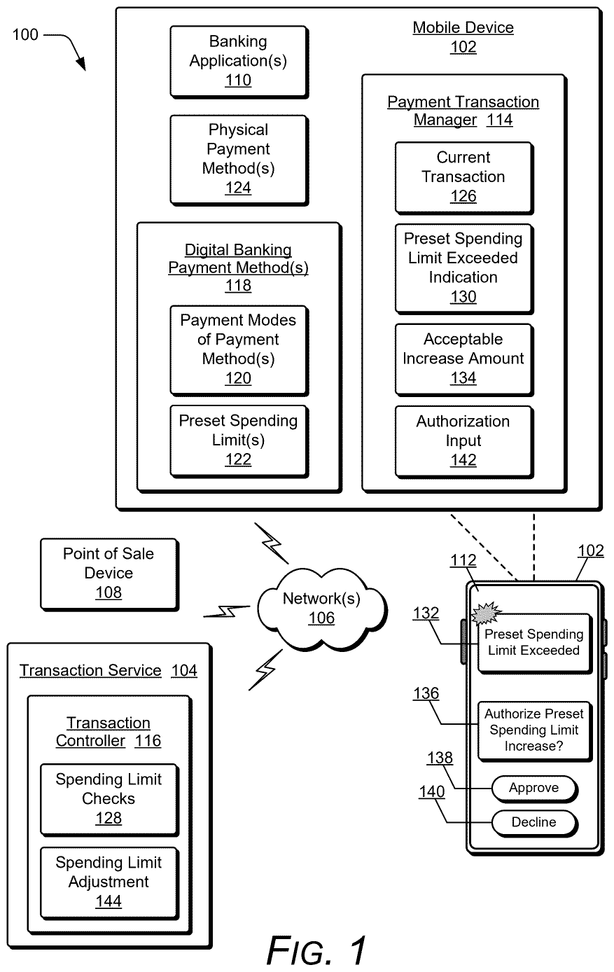

FIG. 1 illustrates an example system 100 for preset spending limit adjustment during a transaction, as described herein. The system 100 includes a mobile device 102, a transaction service 104, and a communication network 106. Examples of mobile device include at least one of any type of a wireless device, mobile device, mobile phone, flip phone, client device, companion device, tablet, computing device, communication device, entertainment device, gaming device, media playback device, or any other type of computing, consumer, and/or electronic device.

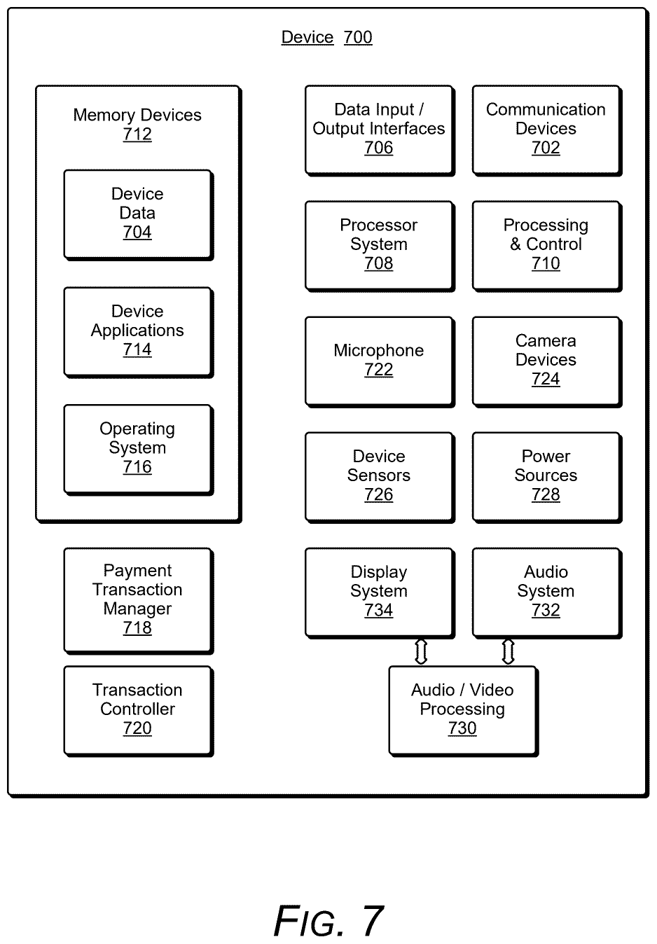

The mobile device 102 can be implemented with various components, such as a processor system and memory, as well as any number and combination of different components as further described with reference to the example device shown in FIG. 7. In implementations, the mobile device 102 includes various radios for wireless communication with other devices. For example, the system and devices can include a Bluetooth (BT) and/or Bluetooth Low Energy (BLE) transceiver, as well as a near field communication (NFC) transceiver. In some cases, the system and devices includes at least one of a WiFi radio, a cellular radio, a global positioning satellite (GPS) radio, or any available type of device communication interface.

In some implementations, the devices, applications, modules, servers, and/or services described herein communicate via the communication network 106, such as for data communication with the mobile device 102. The communication network 106 includes a wired and/or a wireless network. The communication network 106 is implemented using any type of network topology and/or communication protocol, and is represented or otherwise implemented as a combination of two or more networks, to include IP-based networks, cellular networks, and/or the Internet. The communication network 106 includes mobile operator networks that are managed by a mobile network operator and/or other network operators, such as a communication service provider, mobile phone provider, and/or Internet service provider.

The mobile device 102, the transaction service 104, and/or a point-of-sale (POS) device 108 includes various functionality that enables the one or more devices to implement different aspects of preset spending limit adjustment during a transaction, as described herein. In one or more examples, an interface module represents functionality (e.g., logic and/or hardware) enabling the one or more devices to interconnect and interface with other devices and/or networks, such as the communication network 106. For example, an interface module implemented in a device enables wireless and/or wired connectivity of the mobile device 102, the transaction service 104, and/or the POS device 108.

The mobile device 102 can include and implement various device applications, such as any type of messaging application, email application, video communication application, cellular communication application, music/audio application, gaming application, media application, social platform applications, and/or any other of the many possible types of various device applications. In this example, the mobile device 102 includes one or more banking applications 110, such as a banking application that is associated with a digital banking payment method and/or a physical payment method. Many of the device applications have an associated application user interface that is generated and displayed for user interaction and viewing, such as on a display screen 112 of the mobile device 102. Generally, an application user interface, or any other type of video, image, graphic, and the like is digital image content that is displayable on the display screen 112 of the mobile device 102.

In the example system 100 for preset spending limit adjustment during a transaction, the mobile device 102 implements a payment transaction manager 114 (e.g., as a device application). As shown in this example, the payment transaction manager 114 represents functionality (e.g., logic, software, and/or hardware) enabling aspects of the described techniques for preset spending limit adjustment during a transaction. The payment transaction manager 114 can be implemented as computer instructions stored on computer-readable storage media and can be executed by a processor system of the mobile device 102. Alternatively, or in addition, the payment transaction manager 114 can be implemented at least partially in hardware of the device.

Similarly, the transaction service 104 implements a transaction controller 116 (e.g., as a device application). As shown in this example, the transaction controller 116 represents functionality (e.g., logic, software, and/or hardware) enabling aspects of the described techniques for preset spending limit adjustment during a transaction. The transaction controller 116 can be implemented as computer instructions stored on computer-readable storage media and can be executed by a processor system of the mobile device 102. Alternatively, or in addition, the transaction controller 116 can be implemented at least partially in hardware of the device.

In one or more implementations, the payment transaction manager 114 includes independent processing, memory, and/or logic components functioning as a computing and/or electronic device integrated with the mobile device 102. Similarly, the transaction controller 116 may include independent processing, memory, and/or logic components functioning as a computing and/or electronic device integrated with the transaction service 104. Additionally, or alternatively, the payment transaction manager 114 and/or the transaction controller 116 can be implemented in software, in hardware, or as a combination of software and hardware components. In this example, the payment transaction manager 114 and/or the transaction controller 116 is implemented as a software application or module, such as executable software instructions (e.g., computer-executable instructions) that are executable with a processor system of the respective device to implement the techniques and features described herein. As a software application or module, the payment transaction manager 114 and/or the transaction controller 116 can be stored on computer-readable storage memory (e.g., memory of a device), or in any other suitable memory device or electronic data storage implemented with the manager and/or controller. Alternatively or in addition, the payment transaction manager 114 and/or the transaction controller 116 is implemented in firmware and/or at least partially in computer hardware. For example, at least part of the payment transaction manager 114 and/or the transaction controller 116 is executable by a computer processor, and/or at least part of the payment transaction manager and/or the transaction controller is implemented in logic circuitry.

In this example system 100, the mobile device 102 includes digital banking payment methods 118, which are forms of digital payment that the user has setup on the mobile device. For example, the digital banking payment methods 118 may be the digital forms of debit cards, credit cards, charge cards, or other types of electronic payment forms that are backed by banking or finance institutions, and that may be associated with the one or more banking applications 110 on the mobile device. Additionally, each of the digital banking payment methods 118 may have associated one or more payment modes 120 of a digital banking payment method. For example, various payment modes 120 of a digital banking payment method 118 can include tap to pay, swipe to pay, or may be in the form of an online transaction. Further, one or more of the different payment modes 120 of a digital banking payment method may have a different preset spending limit 122. Alternatively, a digital banking payment method 118 may have a common preset spending limit 122 for all the various types of payment modes 120 that are associated with the particular digital banking payment method.

Similarly, the payment transaction manager 114 of the mobile device 102 can associate one or more physical payment methods 124 with a user of the mobile device. The physical payment methods 124 can be debit cards, credit cards, charge cards, or other types of physical payment forms that are backed by banking or finance institutions. These physical payment methods 124 can be determined or attained by the mobile device 102 (e.g., and/or the payment transaction manager 114) based on transactions that the user has initiated with any of the physical debit or credit cards, where information of the transactions is communicated to the mobile device 102, either in the form of security (e.g., seeking a OTP (one time password) or for two-factor authentication) to complete a transaction, or as transaction details via SMS, email, or other forms of transaction receipt notifications. Additionally, or alternatively, the mobile device 102 can receive an input of a physical payment method, such as designated by a user of the mobile device. For example, the user of the mobile device can indicate one (or more) of the physical payment methods 124 that are physically available with the user for POS transactions.

In one or more implementations, a user of the mobile device 102 can initiate a purchase transaction, such as a current transaction 126 at the POS device 108 (e.g., in a retail business) with a digital banking payment method 118 that is stored on the mobile device. Alternatively, the user of the mobile device 102 can initiate the current transaction 126 at the POS device 108 with a physical payment method 124 that is available to the user. The payment transaction manager 114 of the mobile device 102 can detect that the current transaction 126 has been initiated and/or receive an indication that the transaction has been initiated. The POS device 108 communicates transaction details to the transaction service 104, such as the purchase amount and the payment method. The transaction service 104 processes the transaction details for the purchase transaction with spending limit checks 128, including determining whether the digital banking payment method 118 or the physical payment method 124 has enough of a balance to complete the purchase, and whether the purchase amount is within a preset spending limit 122. The preset spending limit 122 may also be associated with a particular payment mode 120 of the payment method.

If the purchase amount of the current transaction 126 exceeds the preset spending limit 122, then the transaction service 104 can communicate and/or interface with the mobile device 102, such as via a banking system and/or via a banking application 110 on the mobile device that is associated with the digital banking payment method 118 or the physical payment method 124. The payment transaction manager 114 of the mobile device 102 can obtain an indication 130 that the purchase amount of the transaction exceeds the preset spending limit 122 for the payment method used for the transaction. For example, the payment transaction manager 114 of the mobile device 102 may determine that the purchase amount of a transaction exceeds the preset spending limit 122, or receive the indication 130 that the purchase amount exceeds the preset spending limit from the transaction service 104. The mobile device 102 can then indicate that the purchase amount of the current transaction 126 exceeds the preset spending limit 122. For example, the display screen 112 of the mobile device can display an alert 132 (or any other type of alert as an image or graphic) in an application user interface to indicate that the present spending limit 122 for the payment method has been exceeded.

In one or more implementations, the payment transaction manager 114 determines whether the purchase amount for the current transaction 126 is within an acceptable increase amount 134 for the transaction. For example, the payment transaction manager 114 determines that the purchase amount of the transaction that has been initiated at the POS device 108 is within an acceptable increase amount 134 over the preset spending limit 122. In implementations, the acceptable increase is a designated amount over the preset spending limit, or the acceptable increase is within a designated percentage (e.g., 10%, 20%, etc.) of the purchase amount of the transaction over the preset spending limit.

The payment transaction manager 114 can then initiate to display, in an application user interface on the display screen 112 of the mobile device 102, a user interface indication 136 that the user of the mobile device can authorize a preset spending limit increase. For example, the user of the mobile device can confirm to increase the preset spending limit by an interactive element 138 that is selectable to “approve” the preset spending limit increase, or the user of the mobile device can decline to increase the preset spending limit by an interactive element 140 that is selectable to “decline” the preset spending limit increase. In implementations, the interactive element 138 that is selectable to “approve” the preset spending limit increase is conditionally displayed based on the purchase amount of the current transaction 126 having been determined within the acceptable increase amount 134.

In one or more implementations, a user of the mobile device 102 can approve the temporary, over-limit transaction, such as via the interface displayed on the mobile device, by voice command, or by any other type of a user approval interaction. For example, the payment transaction manager 114 receives the authorization input 142 as approval from the user to increase the preset spending limit for the current transaction. Additionally, the transaction service 104 receives an indication of the authorization input 142 for the spending limit adjustment 144 to temporarily increase the preset spending limit. In implementations, the transaction service 104 receives the indication of the authorization input 142 from the mobile device 102 and/or via interaction with a banking application 110 or a banking system.

The spending limit adjustment 144 is applied at the transaction service 104 during the current transaction, and the transaction service allows the purchase transaction to go through with approval at the POS device 108. Additionally, or alternatively, the payment transaction manager 114 may authorize the transaction approval with the increased spending limit to the POS device 108. Additionally, the increase of the preset spending limit is temporary and the preset spending limit is reset after the transaction has completed. For example, the payment transaction manager 114 reverts the increase of the preset spending limit 122 to the previous limit after the current transaction 126 is approved at the POS device 108 and is complete.

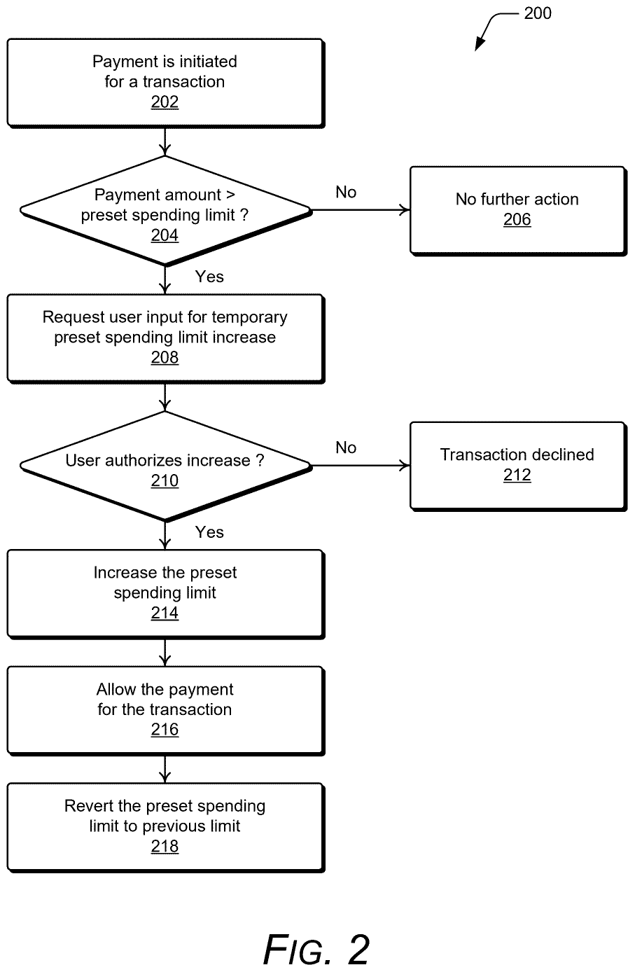

Example methods 200, 300, 400, 500, and 600 are described with reference to respective FIGS. 2-6 in accordance with one or more implementations of preset spending limit adjustment during a transaction, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 2 illustrates an example method 200 of preset spending limit adjustment during a transaction, as described herein. In this example method 200, a payment is initiated for a transaction (at 202). For example, a purchase is initiated at a POS device for a transaction that includes a purchase amount and a payment method, such as a digital banking payment method or a physical payment method.

A determination is made as to whether a payment amount of the transaction is greater than a preset spending limit of the payment method for the transaction (at 204). If the payment amount of the transaction does not exceed the preset spending limit for the payment method, then no further action (at 206). However, if the payment amount of the transaction does exceed the preset spending limit for the payment method, then an input is requested (e.g., a user input) for a temporary preset spending limit increase (at 208).

Another determination is made as to whether a user authorizes the increase in the preset spending limit (at 210). If the increase in the preset spending limit is declined (e.g., not authorized), then the transaction is declined (at 212). However, if the increase in the present spending limit is approved (e.g., authorized by the user), then the preset spending limit is temporarily increased (at 214), and the payment for the transaction is allowed with the payment method (at 216). The preset spending limit is then reverted to the previous limit (at 218).

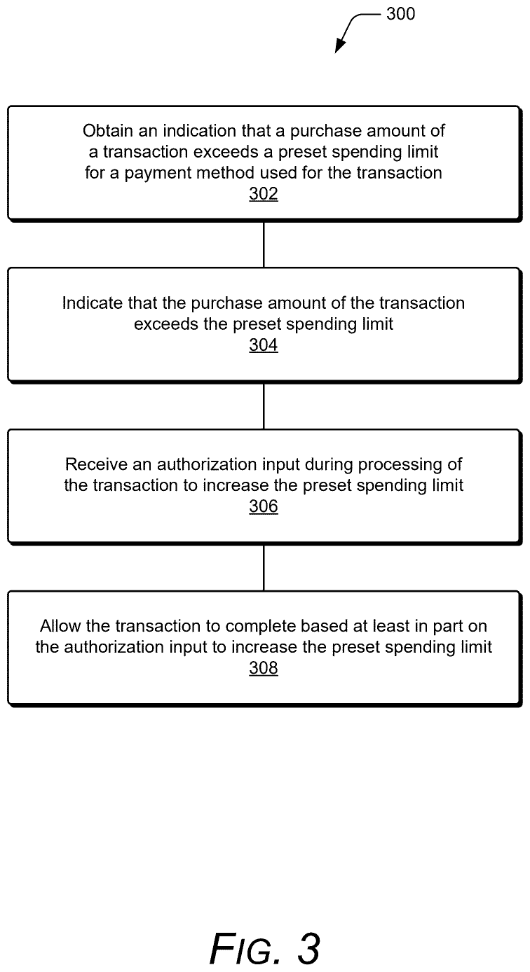

FIG. 3 illustrates example method(s) 300 for preset spending limit adjustment during a transaction. The order in which the method is described is not intended to be construed as a limitation, and any number or combination of the described method operations may be performed in any order to perform a method, or an alternate method.

At 302, an indication is obtained that a purchase amount of a transaction exceeds a preset spending limit for a payment method used for the transaction. For example, the payment transaction manager 114 of the mobile device 102 obtains the indication 130 that the purchase amount of a current transaction 126 exceeds a preset spending limit 122 for the payment method used for the transaction. In implementations, the payment transaction manager 114 determines that the purchase amount of a transaction exceeds the preset spending limit 122, or the payment transaction manager 114 receives the indication 130 that the purchase amount exceeds the preset spending limit from the transaction service 104.

At 304, indicate that the purchase amount of the transaction exceeds the preset spending limit. For example, the payment transaction manager 114 of the mobile device 102 initiates to indicate that the purchase amount of the current transaction 126 exceeds the preset spending limit 122. In implementations, the display screen 112 of the mobile device displays the alert 132 (or any other type of alert as an image or graphic) in an application user interface to indicate that the present spending limit 122 for the payment method of the transaction has been exceeded.

At 306, an authorization input is received during processing of the transaction to increase the preset spending limit. For example, the payment transaction manager 114 of the mobile device 102 receives the authorization input 142 as approval from the user to increase the preset spending limit 122 for the current transaction, during processing of the transaction. Additionally, the transaction service 104 receives an indication of the authorization input 142 for the spending limit adjustment 144 to temporarily increase the preset spending limit, during processing of the transaction. In implementations, the transaction service 104 receives the indication of the authorization input 142 from the mobile device 102 and/or via interaction with a banking application 110 or a banking system.

At 308, the transaction is allowed to complete based on the authorization input to increase the preset spending limit. For example, the payment transaction manager 114 allows the current transaction 126 to be completed based on the authorization input 142 to increase the preset spending limit 122 for the payment method. In implementations, the spending limit adjustment 144 is applied at the transaction service 104 during the current transaction, and the transaction service allows the purchase transaction to go through with approval at the POS device 108. Additionally, or alternatively, the payment transaction manager 114 authorizes the transaction approval with the increased spending limit to the POS device 108.

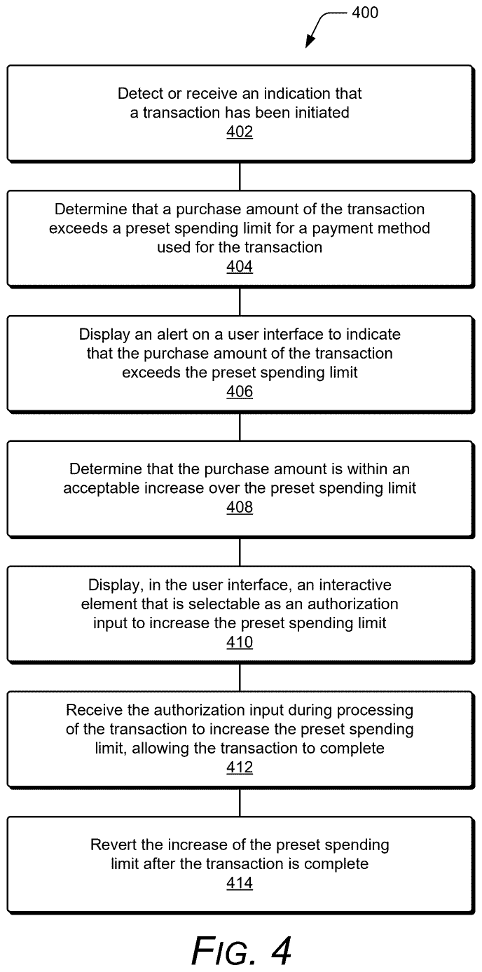

FIG. 4 illustrates example method(s) 400 for preset spending limit adjustment during a transaction. The order in which the method is described is not intended to be construed as a limitation, and any number or combination of the described method operations may be performed in any order to perform a method, or an alternate method.

At 402, detect or receive an indication that a transaction has been initiated. For example, the payment transaction manager 114 detects or receives an indication that a current transaction 126 has been initiated, such as an indication received from a banking application 110 on the mobile device and/or an indication received from the POS device 108 and/or from the transaction service 104 when a payment transaction is initiated with a digital banking payment method 118 or a physical payment method 124.

At 404, a determination is made that a purchase amount of the transaction exceeds a preset spending limit for a payment method used for the transaction. For example, the payment transaction manager 114 of the mobile device 102 and/or the transaction controller 116 of the transaction service 104 determines that a purchase amount of the current transaction 126 exceeds the preset spending limit 122 for the payment method used for the transaction. The purchase amount of the current transaction 126 may also exceed the preset spending limit 122 for a particular payment mode 120 of the payment method used for the transaction at the POS device 108.

At 406, an alert is displayed on a user interface to indicate that the purchase amount of the transaction exceeds the preset spending limit. For example, the payment transaction manager 114 of the mobile device 102 initiates to display an alert to indicate that the purchase amount of the current transaction 126 exceeds the preset spending limit 122. In implementations, the display screen 112 of the mobile device displays the alert 132 (or any other type of alert as an image or graphic) in an application user interface to indicate that the present spending limit 122 for the payment method of the transaction has been exceeded.

At 408, a determination is made that the purchase amount is within an acceptable increase over the preset spending limit. For example, the payment transaction manager 114 of the mobile device 102 determines whether the purchase amount of the transaction that has been initiated at the POS device 108 is within an acceptable increase amount 134 over the preset spending limit 122. In implementations, the acceptable increase is a designated amount over the preset spending limit, or the acceptable increase is within a designated percentage (e.g., 10%, 20%, etc.) of the purchase amount of the transaction over the preset spending limit.

At 410, an interactive element that is selectable as an authorization input to increase the preset spending limit is displayed in a user interface. For example, the payment transaction manager 114 initiates to display the user interface indication 136 that the user of the mobile device can authorize a preset spending limit increase. The user of the mobile device 102 can confirm to increase the preset spending limit by the interactive element 138 that is selectable to “approve” the preset spending limit increase, or the user of the mobile device can decline to increase the preset spending limit by the interactive element 140 that is selectable to “decline” the preset spending limit increase. In implementations, the interactive element 138 that is selectable to “approve” the preset spending limit increase is conditionally displayed based on the purchase amount of the current transaction 126 having been determined within the acceptable increase amount 134.

At 412, the authorization input is received during processing of the transaction to increase the preset spending limit, allowing the transaction to complete. For example, the payment transaction manager 114 of the mobile device 102 receives the authorization input 142 as approval from the user to increase the preset spending limit 122 for the current transaction, during processing of the transaction. Additionally, the transaction service 104 receives an indication of the authorization input 142 for the spending limit adjustment 144 to temporarily increase the preset spending limit, during processing of the transaction. In implementations, the transaction service 104 receives the indication of the authorization input 142 from the mobile device 102 and/or via interaction with a banking application 110 or a banking system. Additionally, the payment transaction manager 114 allows the current transaction 126 to be completed based on the authorization input 142 to increase the preset spending limit 122 for the payment method. In implementations, the spending limit adjustment 144 is applied at the transaction service 104 during the current transaction, and the transaction service allows the purchase transaction to go through with approval at the POS device 108. Additionally, or alternatively, the payment transaction manager 114 authorizes the transaction approval with the increased spending limit to the POS device 108.

At 414, the increase of the preset spending limit is reverted after the transaction is complete. For example, the payment transaction manager 114 reverts the increase of the preset spending limit 122 to the previous limit after the current transaction 126 is approved at the POS device 108 and is complete. In implementations, the increase of the preset spending limit 122 for the payment method and/or the payment mode of the payment method is temporary, and the preset spending limit is reset after the transaction has been allowed to process and completed.

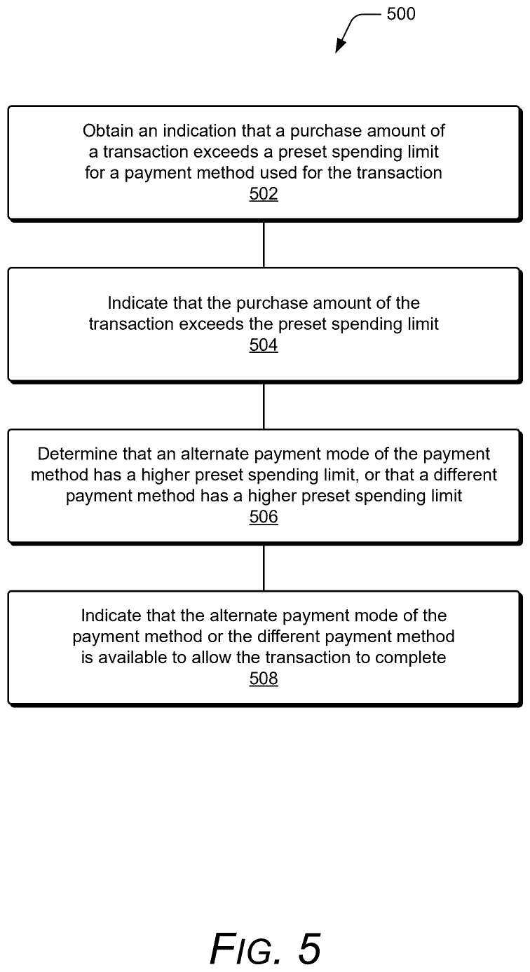

FIG. 5 illustrates example method(s) 500 for preset spending limit adjustment during a transaction. The order in which the method is described is not intended to be construed as a limitation, and any number or combination of the described method operations may be performed in any order to perform a method, or an alternate method.

At 502, an indication is obtained that a purchase amount of a transaction exceeds a preset spending limit for a payment method used for the transaction. For example, the payment transaction manager 114 of the mobile device 102 obtains the indication 130 that the purchase amount of a current transaction 126 exceeds a preset spending limit 122 for the payment method used for the transaction. In implementations, the payment transaction manager 114 determines that the purchase amount of a transaction exceeds the preset spending limit 122, or the payment transaction manager 114 receives the indication 130 that the purchase amount exceeds the preset spending limit from the transaction service 104.

At 504, indicate that the purchase amount of the transaction exceeds the preset spending limit. For example, the payment transaction manager 114 of the mobile device 102 initiates to indicate that the purchase amount of the current transaction 126 exceeds the preset spending limit 122. In implementations, the display screen 112 of the mobile device displays the alert 132 (or any other type of alert as an image or graphic) in an application user interface to indicate that the present spending limit 122 for the payment method of the transaction has been exceeded.

At 506, a determination is made that an alternate payment mode of the payment method has a higher preset spending limit, or a different payment method has a higher preset spending limit. For example, the payment transaction manager 114 can determine that an alternate payment mode 120 of the payment method used for the current transaction 126 has a higher preset spending limit, and/or determine that a different payment method has a higher preset spending limit. The various payment modes 120 of a digital banking payment method 118 or a physical payment method 124 can include tap to pay, swipe to pay, or may be in the form of an online transaction. Further, one or more of the different payment modes 120 of a payment method may have a different preset spending limit 122. Alternatively, a digital banking payment method 118 or physical payment method 124 may have a common preset spending limit 122 for all the various types of payment modes 120 that are associated with the particular payment method.

At 508, indicate that the alternate payment mode of the payment method or the different payment method is available to allow the transaction to complete. For example, the payment transaction manager 114 of the mobile device 102 initiates to indicate that an alternate payment mode 120 of the payment method, or a different payment method, is available to overcome the preset spending limit being exceeded. In implementations, the display screen 112 of the mobile device can display the indication of an alternate payment mode 120 or a different payment method for user selection to change the payment method for the current transaction.

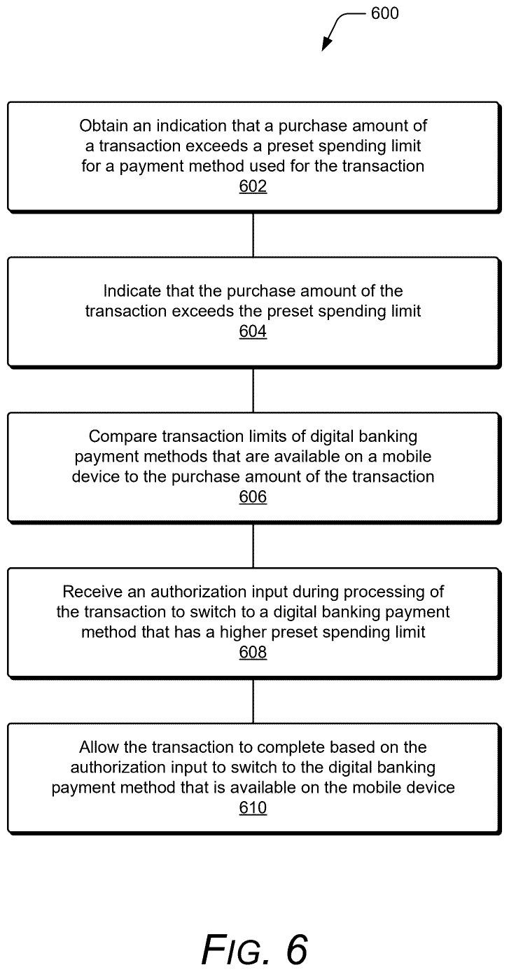

FIG. 6 illustrates example method(s) 600 for preset spending limit adjustment during a transaction. The order in which the method is described is not intended to be construed as a limitation, and any number or combination of the described method operations may be performed in any order to perform a method, or an alternate method.

At 602, an indication is obtained that a purchase amount of a transaction exceeds a preset spending limit for a payment method used for the transaction. For example, the payment transaction manager 114 of the mobile device 102 obtains the indication 130 that the purchase amount of a current transaction 126 exceeds a preset spending limit 122 for the payment method used for the transaction. In implementations, the payment transaction manager 114 determines that the purchase amount of a transaction exceeds the preset spending limit 122, or the payment transaction manager 114 receives the indication 130 that the purchase amount exceeds the preset spending limit from the transaction service 104.

At 604, indicate that the purchase amount of the transaction exceeds the preset spending limit. For example, the payment transaction manager 114 of the mobile device 102 initiates to indicate that the purchase amount of the current transaction 126 exceeds the preset spending limit 122. In implementations, the display screen 112 of the mobile device displays the alert 132 (or any other type of alert as an image or graphic) in an application user interface to indicate that the present spending limit 122 for the payment method of the transaction has been exceeded.

At 606, transaction limits of digital banking payment methods available on the mobile device are compared to the purchase amount of the transaction. For example, the payment transaction manager 114 compares the preset spending limits 122 for the digital banking payment methods 118 that are available on the mobile device 102 to the purchase amount of the current transaction 126 (which has exceeded the preset spending limit of the current selected payment method). Additionally, the payment transaction manager 114 can initiate to display an indication for user selection to select or approve an alternate payment method that has a preset spending limit 122 higher than the purchase amount of the current transaction.

At 608, an authorization input is received during processing of the transaction to switch to a digital banking payment method that has a higher preset spending limit. For example, the payment transaction manager 114 of the mobile device 102 receives the authorization input 142 as approval from the user of the mobile device 102 to switch to an alternate payment method, such as an alternate payment method that has a preset spending limit 122 higher than the purchase amount of the current transaction. In implementations, the alternate payment method is a different digital banking payment method 118, or a physical payment method 124 (or vice-versa). In implementations, the transaction service 104 receives the indication of the alternate, selected payment method from the mobile device 102 and/or via interaction with a banking application 110 or a banking system.

At 610, the transaction is allowed to complete based on the authorization input to switch to the digital banking payment method that is available on the mobile device. For example, the payment transaction manager 114 allows the current transaction 126 to be completed based on an authorization input to switch to a payment method that has a higher preset spending limit. In implementations, the spending limit adjustment 144 is applied at the transaction service 104 during the current transaction, and the transaction service allows the purchase transaction to go through with approval at the POS device 108. Additionally, or alternatively, the payment transaction manager 114 authorizes the transaction approval using the alternate payment method with the increased spending limit to the POS device 108.

FIG. 7 illustrates various components of an example device 700, which can implement aspects of the techniques and features for preset spending limit adjustment during a transaction, as described herein. The example device 700 may be implemented as any of the devices described with reference to the previous FIGS. 1-6, such as any type of a wireless device, mobile device, mobile phone, flip phone, client device, companion device, display device, tablet, computing, communication, entertainment, gaming, media playback, and/or any other type of computing, consumer, and/or electronic device. For example, the mobile device 102, the transaction service 104, and/or the point-of-sale (POS) device 108 described with reference to FIGS. 1-6 may be implemented as the example device 700.

The example device 700 can include various, different communication devices 702 that enable wired and/or wireless communication of device data 704 with other devices. The device data 704 can include any of the various devices data and content that is generated, processed, determined, received, stored, and/or communicated from one computing device to another. Generally, the device data 704 can include any form of audio, video, image, graphics, and/or electronic data that is generated by applications executing on a device. The communication devices 702 can also include transceivers for cellular phone communication and/or for any type of network data communication.

The example device 700 can also include various, different types of data input / output (I/O) interfaces 706, such as data network interfaces that provide connection and/or communication links between the devices, data networks, and other devices. The data I/O interfaces 706 may be used to couple the device to any type of components, peripherals, and/or accessory devices, such as a computer input device that may be integrated with the example device 700. The I/O interfaces 706 may also include data input ports via which any type of data, information, media content, communications, messages, and/or inputs may be received, such as user inputs to the device, as well as any type of audio, video, image, graphics, and/or electronic data received from any content and/or data source.

The example device 700 includes a processor system 708 of one or more processors (e.g., any of microprocessors, controllers, and the like) and/or a processor and memory system implemented as a system-on-chip (SoC) that processes computer-executable instructions. The processor system 708 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 710. The example device 700 may also include any type of a system bus or other data and command transfer system that couples the various components within the device. A system bus can include any one or combination of different bus structures and architectures, as well as control and data lines.

The example device 700 also includes memory and/or memory devices 712 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 712 include volatile memory and non-volatile memory, fixed and removable media devices, and any suitable memory device or electronic data storage that maintains data for computing device access. The memory devices 712 can include various implementations of random-access memory (RAM), read-only memory (ROM), flash memory, and other types of storage media in various memory device configurations. The example device 700 may also include a mass storage media device.

The memory devices 712 (e.g., as computer-readable storage memory) provide data storage mechanisms, such as to store the device data 704, other types of information and/or electronic data, and various device applications 714 (e.g., software applications and/or modules). For example, an operating system 716 may be maintained as software instructions with a memory device 712 and executed by the processor system 708 as a software application. The device applications 714 may also include a device manager, such as any form of a control application, software application, signal-processing and control module, code that is specific to a particular device, a hardware abstraction layer for a particular device, and so on.

In this example, the device 700 includes a payment transaction manager 718 and/or a transaction controller 720 that implements various aspects of the described features and techniques described herein. The payment transaction manager 718 and/or the transaction controller 720 may be implemented with hardware components and/or in software as one of the device applications 714, such as when the example device 700 is implemented as the mobile device 102 or the transaction service 104 described with reference to FIGS. 1-6. An example of the payment transaction manager 718 is the payment transaction manager 114 implemented by the mobile device 102, such as a software application and/or as hardware components in the mobile device. An example of the transaction controller 720 is the transaction controller 116 implemented by the transaction service 104, such as a software application and/or as hardware components in the transaction service. In implementations, the payment transaction manager 718 and/or the transaction controller 720 may include independent processing, memory, and logic components as a computing and/or electronic device integrated with the example device 700.

The example device 700 can also include a microphone 722 (e.g., to capture an audio recording) and/or camera devices 724 (e.g., to capture video images), as well as device sensors 726, such as may be implemented as components of an inertial measurement unit (IMU). The device sensors 726 may be implemented with various sensors, such as a gyroscope, an accelerometer, and/or other types of motion sensors to sense motion of the device. The device sensors 726 can generate sensor data vectors having three-dimensional parameters (e.g., rotational vectors in x, y, and z-axis coordinates) indicating location, position, acceleration, rotational speed, and/or orientation of the device. The example device 700 can also include one or more power sources 728, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 700 can also include an audio and/or video processing system 730 that generates audio data for an audio system 732 and/or generates display data for a display system 734. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 700. Alternatively, the audio system and/or the display system are external, peripheral components to the example device.

Although implementations for preset spending limit adjustment during a transaction have been described in language specific to features and/or methods, the appended claims are not necessarily limited to the specific features or methods described. Rather, the specific features and methods are disclosed as example implementations for preset spending limit adjustment during a transaction, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A mobile device, including: at least one memory and at least one processor coupled with the at least one memory and configured to cause the mobile device to obtain an indication that a purchase amount of a transaction exceeds a preset spending limit for a payment method used for the transaction; indicate that the purchase amount of the transaction exceeds the preset spending limit; receive an authorization input during processing of the transaction to increase the preset spending limit; and allow the transaction to complete based on the authorization input to increase the preset spending limit.

Alternatively, or in addition to the above-described mobile device, any one or combination of: the at least one processor is configured to cause the mobile device to one of detect that the transaction has been initiated or receive the indication that the transaction has been initiated. To receive the authorization input, the at least one processor is configured to cause the mobile device to receive a selectable input to an interactive element that is displayed in a user interface. The at least one processor is configured to cause the mobile device to: determine that the purchase amount is within an acceptable increase over the preset spending limit, the acceptable increase being one of a designated amount over the preset spending limit, or within a designated percentage of the purchase amount over the preset spending limit; and display, in a user interface, an interactive element that is selectable as the authorization input to increase the preset spending limit, the interactive element conditionally displayed based on the purchase amount being determined within the acceptable increase. To obtain the indication that the purchase amount of the transaction exceeds the preset spending limit, the at least one processor is configured to cause the mobile device to one of determine that the purchase amount exceeds the preset spending limit, or receive the indication that the purchase amount exceeds the preset spending limit. To indicate that the purchase amount of the transaction exceeds the preset spending limit, the at least one processor is configured to cause the mobile device to display an alert on a user interface. An increase of the preset spending limit is temporary and the preset spending limit is reset after the transaction has complete. The at least one processor is configured to cause the mobile device to revert an increase of the preset spending limit after the transaction is complete. The payment method used for the transaction is one of a digital banking payment method or a physical payment method, and the preset spending limit corresponds to a payment mode of the digital banking payment method or the physical payment method.

A method, including: obtaining an indication that a purchase amount of a transaction exceeds a preset spending limit for a payment method used for the transaction; indicating that the purchase amount of the transaction exceeds the preset spending limit; receiving an authorization input during processing of the transaction to increase the preset spending limit; and allowing the transaction to complete based on the authorization input to increase the preset spending limit.

Alternatively, or in addition to the above-described method, any one or combination of: the method including one of detecting that the transaction has been initiated or receiving the indication that the transaction has been initiated. The method including receiving the authorization input as a selection of an interactive element that is displayed in a user interface. The method including determining that the purchase amount is within an acceptable increase over the preset spending limit, the acceptable increase being one of a designated amount over the preset spending limit, or within a designated percentage of the purchase amount over the preset spending limit; and displaying, in a user interface, an interactive element that is selectable as the authorization input to increase the preset spending limit. The method including displaying an alert on a user interface to indicate that the purchase amount of the transaction exceeds the preset spending limit. The method including reverting an increase of the preset spending limit after the transaction is complete. The payment method used for the transaction is one of a digital banking payment method or a physical payment method, and the preset spending limit corresponds to a payment mode of the digital banking payment method or the physical payment method.

A mobile device, including: at least one memory and at least one processor coupled with the at least one memory and configured to cause the mobile device to obtain an indication that a purchase amount of a transaction exceeds a preset spending limit for a payment method used for the transaction; indicate that the purchase amount of the transaction exceeds the preset spending limit; determine at least one of an alternate payment mode of the payment method has a higher preset spending limit, or a different payment method has the higher preset spending limit; and indicate one of the alternate payment mode of the payment method or the different payment method is available to allow the transaction to complete.

Alternatively, or in addition to the above-described mobile device, any one or combination of: a payment mode of the payment method is at least one of a point-of-sale transaction, a tap to pay transaction, a swipe to pay transaction, or an online transaction. At least one of the payment method is a digital banking payment method, and the different payment method is a physical payment method that is available with a user of the mobile device; or the payment method is the physical payment method, and the different payment method is the digital banking payment method. The at least one processor is configured to cause the mobile device to compare transaction limits of digital banking payment methods available on the mobile device to the purchase amount of the transaction; receive an authorization input during processing of the transaction to switch to a digital banking payment method as the different payment method, where the digital banking payment method has the higher preset spending limit; and allow the transaction to complete based on the authorization input to switch to the digital banking payment method that is available on the mobile device.

1. A mobile device, comprising:
at least one memory; and
at least one processor coupled with the at least one memory and configured to cause the mobile device to:
obtain an indication that a purchase amount of a transaction exceeds a preset spending limit for a payment method used for the transaction;
indicate that the purchase amount of the transaction exceeds the preset spending limit;
receive an authorization input during processing of the transaction to increase the preset spending limit; and
allow the transaction to complete based at least in part on the authorization input to increase the preset spending limit.

2. The mobile device of claim 1, wherein the at least one processor is configured to cause the mobile device to one of detect that the transaction has been initiated or receive the indication that the transaction has been initiated.

3. The mobile device of claim 1, wherein, to receive the authorization input, the at least one processor is configured to cause the mobile device to receive a selectable input to an interactive element that is displayed in a user interface.

4. The mobile device of claim 1, wherein the at least one processor is configured to cause the mobile device to:
determine that the purchase amount is within an acceptable increase over the preset spending limit, the acceptable increase being one of a designated amount over the preset spending limit, or within a designated percentage of the purchase amount over the preset spending limit; and
display, in a user interface, an interactive element that is selectable as the authorization input to increase the preset spending limit, the interactive element conditionally displayed based on the purchase amount being determined within the acceptable increase.

5. The mobile device of claim 1, wherein, to obtain the indication that the purchase amount of the transaction exceeds the preset spending limit, the at least one processor is configured to cause the mobile device to one of determine that the purchase amount exceeds the preset spending limit, or receive the indication that the purchase amount exceeds the preset spending limit.

6. The mobile device of claim 1, wherein, to indicate that the purchase amount of the transaction exceeds the preset spending limit, the at least one processor is configured to cause the mobile device to display an alert on a user interface.

7. The mobile device of claim 1, wherein an increase of the preset spending limit is temporary and the preset spending limit is reset after the transaction has complete.

8. The mobile device of claim 1, wherein the at least one processor is configured to cause the mobile device to revert an increase of the preset spending limit after the transaction is complete.

9. The mobile device of claim 1, wherein the payment method used for the transaction is one of a digital banking payment method or a physical payment method, and the preset spending limit corresponds to a payment mode of the digital banking payment method or the physical payment method.

10. A method, comprising:
obtaining an indication that a purchase amount of a transaction exceeds a preset spending limit for a payment method used for the transaction;
indicating that the purchase amount of the transaction exceeds the preset spending limit;
receiving an authorization input during processing of the transaction to increase the preset spending limit; and
allowing the transaction to complete based at least in part on the authorization input to increase the preset spending limit.

11. The method of claim 10, further comprising one of detecting that the transaction has been initiated or receiving the indication that the transaction has been initiated.

12. The method of claim 10, further comprising receiving the authorization input as a selection of an interactive element that is displayed in a user interface.

13. The method of claim 10, further comprising:
determining that the purchase amount is within an acceptable increase over the preset spending limit, the acceptable increase being one of a designated amount over the preset spending limit, or within a designated percentage of the purchase amount over the preset spending limit; and
displaying, in a user interface, an interactive element that is selectable as the authorization input to increase the preset spending limit.

14. The method of claim 10, further comprising displaying an alert on a user interface to indicate that the purchase amount of the transaction exceeds the preset spending limit.

15. The method of claim 10, further comprising reverting an increase of the preset spending limit after the transaction is complete.

16. The method of claim 10, wherein the payment method used for the transaction is one of a digital banking payment method or a physical payment method, and the preset spending limit corresponds to a payment mode of the digital banking payment method or the physical payment method.

17. A mobile device, comprising:
at least one memory; and
at least one processor coupled with the at least one memory and configured to cause the mobile device to:
obtain an indication that a purchase amount of a transaction exceeds a preset spending limit for a payment method used for the transaction;
indicate that the purchase amount of the transaction exceeds the preset spending limit;
determine at least one of an alternate payment mode of the payment method has a higher preset spending limit, or a different payment method has the higher preset spending limit; and
indicate one of the alternate payment mode of the payment method or the different payment method is available to allow the transaction to complete.

18. The mobile device of claim 17, wherein a payment mode of the payment method is at least one of a point-of-sale transaction, a tap to pay transaction, a swipe to pay transaction, or an online transaction.

19. The mobile device of claim 17, wherein at least one of:
the payment method is a digital banking payment method, and the different payment method is a physical payment method that is available with a user of the mobile device; or
the payment method is the physical payment method, and the different payment method is the digital banking payment method.

20. The mobile device of claim 17, wherein the at least one processor is configured to cause the mobile device to:
compare transaction limits of digital banking payment methods available on the mobile device to the purchase amount of the transaction;
receive an authorization input during processing of the transaction to switch to a digital banking payment method as the different payment method, wherein the digital banking payment method has the higher preset spending limit; and
allow the transaction to complete based at least in part on the authorization input to switch to the digital banking payment method that is available on the mobile device.
